(19) United States
(12) Patent Application Publication
(10) Pub. No.: US 2003/0063096 A1
(43) Pub. Date: Apr. 3, 2003

(54) System and method for efficiently creating a surface map

(76) Inventor: Gregory Michael Burke, Encinitas, CA (US)

Correspondence Address: FUESS & DAVIDENAS, Suite II-G, 10951 Sorrento Valley Road, San Diego, CA, 92121-1613, US

(21) Appl. No.: 10/219,953

(22) Filed: Aug. 14, 2002

Related U.S. Application Data
(60) Provisional application No. 60/312,605, filed on Aug. 15, 2001.

(51) Int. Cl. G09G 5/00

(52) U.S. Cl. 345/582

(57) ABSTRACT

Both geometry and detail of an object's surface are simultaneously analyzed so as to generate a minimal set of data necessary to display the object with minimal visible errors at maximum drawing speed. All knowledge about the surface from high-level definitions (such as triangles, non-uniform rational B-splines (NURBS), textures, etc.) reduced into an internal form (a surface map) is (i) optimized according to visibility rules and (ii) output as a minimized set of machine code (triangles with position, color and normals) to a processor, e.g., a specific graphic processor. Shapes and groups (areas of common lighting and material type) representing an object are first identified. Data in each group is then re-sampled as a vector-valued field in a parametric U and V grid space. The surface map is then optimized by removing data points in both the U and V directions based upon a visibility function that determines which surface data most substantially contributes to the perceived distinctiveness of the representation. After removing unnecessary data points, the points are reconnected to form polygons, which are then split into a set of triangles used to display the surface at high speed with minimal visible errors over a variety of scale factors.

### REFERENCE TO A RELATED PATENT APPLICATION

The present application is related to, and claims benefit of priority of, U.S. provisional patent application serial No. 60/312,605 having the same name filed on Aug. 15, 2001.

### BACKGROUND OF THE INVENTION

1. Field of the Invention

The present invention relates to the field of computer graphics and more particularly to systems and methods for representing visual and physical approximations of real-world objects using polygons.

2. Description of Background Art

Conventional graphic generation systems have a variety of factors that affect the efficiency and quality of a displayed image. Current graphic processing systems use triangles and texture maps to recreate an object. The number of triangles, their size in pixels and the size of the texture maps all contribute to the processing time and hence speed of the display. The size of the data and texture maps becomes a bandwidth problem for hardware busses. Current technology uses large triangles and low resolution texture maps to achieve high frame rates for video games. This works well only if the scene is full of large flat areas (since triangles are flat). To add quality to curved surfaces and small geometric detail, triangles must be made smaller. The processing of the triangle vertices and the pixel plotting are performed in parallel. The ideal sized triangles are at the balance point between the two (or more) processors. In modem graphic hardware, this balance point is between 10 to 20 pixels per triangle. Conventional systems processes geometric spatial detail and surface detail separately, e.g., as triangles and textures.

What is needed is a system and method that analyzes both geometry and surface detail simultaneously and generates the minimal set of data necessary to display an object without visible errors.

### SUMMARY OF THE INVENTION

The present invention is a system and method that analyzes both geometry and surface detail simultaneously and generates the minimal set of data necessary to display an object without having visible errors. The present invention generates a compiled data set of the maximum quality (having a minimum number or near minimum number of visible errors) with the minimum (or near minimum) amount of data and triangles at a given viewing resolution, for maximum drawing speed.

The present invention operates in a manner similar to a surface compiler for data from standard programs and sources. Like a conventional code compiler, the present invention assimilates all knowledge about the surface from high-level definitions (such as triangles, non-uniform rational B-splines (NURBS), textures, etc.) into its internal form (a surface map). This is then optimized according to visibility rules and output as a minimized set of machine code (triangles with position, color and normals) for a processor, e.g., a specific graphic processor.

The present invention identifies the shapes and groups (areas of common lighting and material type) representing an object. The present invention re-samples the data in each group as a vector-valued field in a parametric U and V grid space. This space is not the same as the texture UV space. Since all surfaces can be reduced to a set of topologically 2d surfaces, this forms a 2D Surface Map that includes information at each vertex such as position (xyz), normal (ijk) and diffuse color (rgb) and other data. This data includes the effects of all texture information. Samples are tested for continuity in various subspaces of the vector field and more samples are added if necessary to ensure that enough points are identified to satisfy the Nyquist limit.

The surface map is then optimized by removing data points in both the U and V directions based upon a visibility function that determines which surface data can actually contribute to the perceived distinctiveness of the representation. After removing unnecessary data points, the points are reconnected to form polygons, which are then split into triangles. The resulting triangle set can be displayed at high speed and will have minimal visible errors with a variety of scale factors.

### BRIEF DESCRIPTION OF THE DRAWINGS

FIG. 1 is an illustration of a surface map creation system according to one embodiment of the present invention.

FIG. 2 is a flow chart of the surface map creation process according to one embodiment of the present invention.

FIG. 3 is a flowchart describing the method for optimizing a group according to one embodiment of the present invention.

FIG. 4 is a flowchart describing the method for creating triangles for a group according to one embodiment of the present invention.

FIG. 5 is an illustration of set of sample points representing a group according to one embodiment of the present invention.

FIG. 6 is an illustration of an example of the U cleaning procedure according to one embodiment of the present invention.

FIG. 7 is an illustration of an example of the U cleaning procedure with some points removed according to one embodiment of the present invention.

FIG. 8 is an illustration of a result of a V-line creation process for an example according to one embodiment of the present invention.

FIG. 9 is an illustration of the V-cleaning procedure for an example according to one embodiment of the present invention.

FIG. 10 is an illustration of the V-cleaning procedure with some points removed for an example according to one embodiment of the present invention.

FIG. 11 is an illustration of an example of the triangle creation process according to one embodiment of the present invention.

FIG. 12, consisting of FIGS. 12a and 12b, is in FIG. 12a an illustration of the definition of “Visibility Error” according to one embodiment of the present invention; and in FIG. 12b an illustration of the definition of “Radius Error” according to one embodiment of the present invention.

### DETAILED DESCRIPTION OF THE PREFERRED EMBODIMENTS

A preferred embodiment of the present invention is now described with reference to the figures where like reference numbers indicate identical or functionally similar elements. Also in the figures, the left most digit(s) of each reference number corresponds to the figure in which the reference number is first used.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, usually coupled to a computer system bus. Furthermore, the computers referred to in the specification may include a single processor or may be architectures employing multiple processors or other designs for increased computing capability.

The algorithms and displays presented herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein.

It is also noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

Surface Map Creation

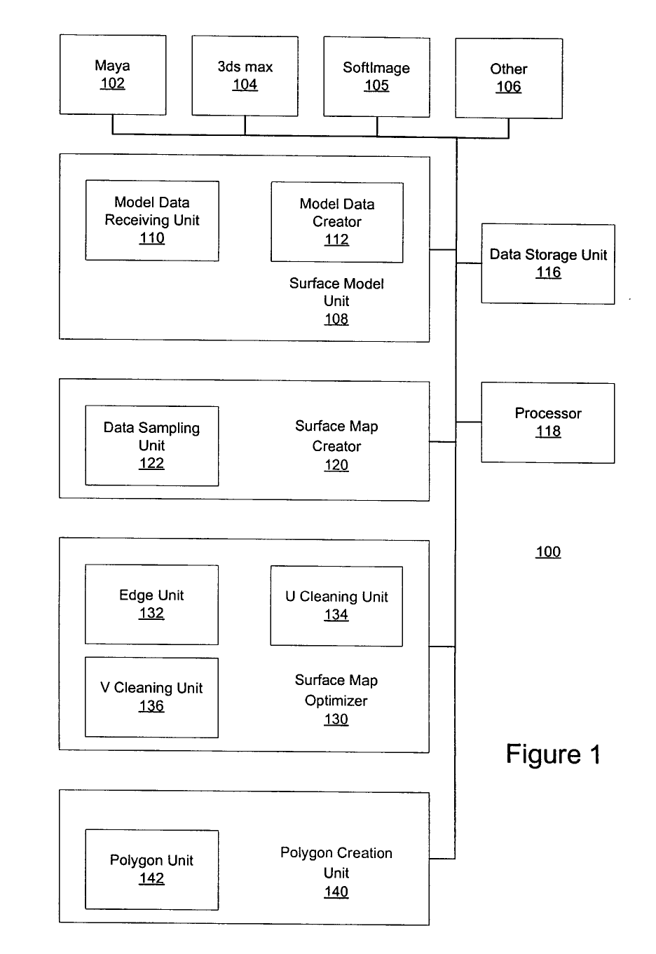

FIG. 1 is an illustration of a surface map creation system 100 according to one embodiment of the present invention. A variety of conventional programs may be used to generate input data for the present invention. One conventional program is Maya 102, which is commercially available from Alias/Wavefront, located in Ontario, Canada. Other conventional programs include 3ds max 104, that is commercially available from Discreet, located in Montreal, Canada, and Softimage 105, that is commercially available from Softimage Company, located in Montreal, Canada. Other 106 sources of data can also be used such as other animation packages and any source that stores data in any industry standard polygon storage format, e.g., 3ds file format.

A conventional data storage unit 116 that may include volatile and non-volatile memory is used by the system, as is a conventional processor 118 such as the Pentium 4 that is commercially available from Intel Corporation, located in Santa Clara, Calif. Alternatively, the processor 118 can comprise multiple processors, e.g., a central processing unit (CPU) and a graphics processing unit (GPU). The present invention includes a surface model unit 108 that has a model data receiving unit 110 and a model data creator 112. The present invention also includes a surface map creator 120 that has a data sampling unit 122. The present invention also includes a surface map optimizer 130 that has an edge unit 132, a U cleaning unit 134, and a V cleaning unit 136. The present invention also includes a polygon creation unit 140 that has a polygon unit 142. These elements are described in greater detail below.

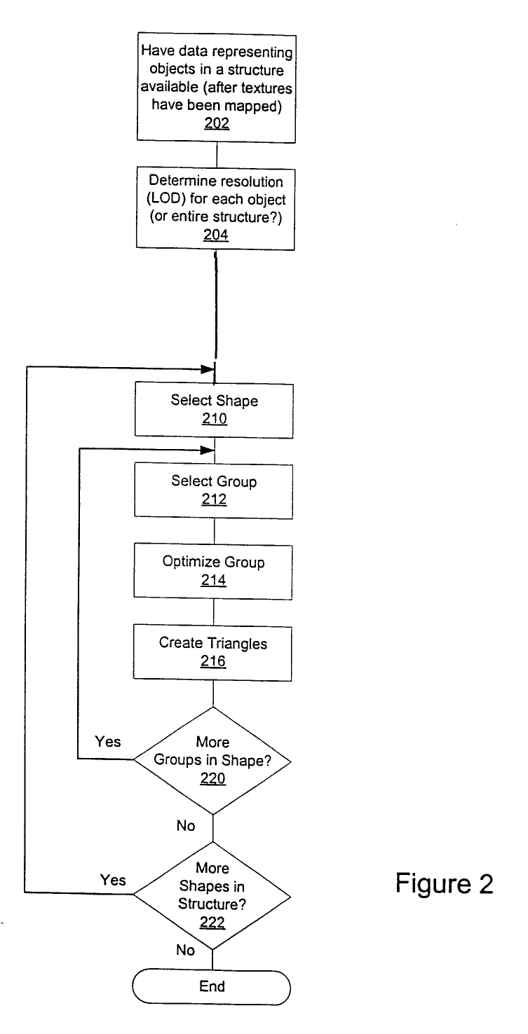

FIG. 2 is a flow chart of the surface map creation process according to one embodiment of the present invention. The Surface model unit 108 receives 202 data about an image structure. In one embodiment of the present invention the data is received from Maya 102. Maya 102 creates an image of the structure by performing the mapping of the color map and all texture maps associated with the structure. Other techniques for generating the data can also be used, e.g., using 3ds Max 104 or other techniques. The present invention then uses this resulting image as a data source. Maya 102 identifies various shapes within the structure and identifies one or more groups with each shape. Each shape has one or more groups. Each group has the same material and lighting response attributes and may share global edges with other groups in the shape.

The surface map creator 120 samples 206 the image data from one of the sources (102, 104, 106) and ensures that no under-sampling occurs as described below. For each sampled point, the model data receiving unit 110 receives data representing the position of the point (e.g., “XYZ”) the color of the point (including vertex color, mapped textures, and static lighting effects) (e.g., “RGB”), and normal information (e.g., “IJK”) that can be determined by a variety of techniques such as the conventional ray tracing technique used in Maya 102. The model data creator 112 uses a data structure to identify the relationship between the received sample points. In one embodiment of the present invention each sample point is identified as a position on a Surface map (UV) and has nine dimensions, i.e., “X, Y, Z, I, J, K, R, G, B.” Two adjacent sample points, e.g., 502A and 502H, are properly sampled if the distance between them is less than 1 projected pixel (based on an identified variance in the viewing distance and transformation matrix).

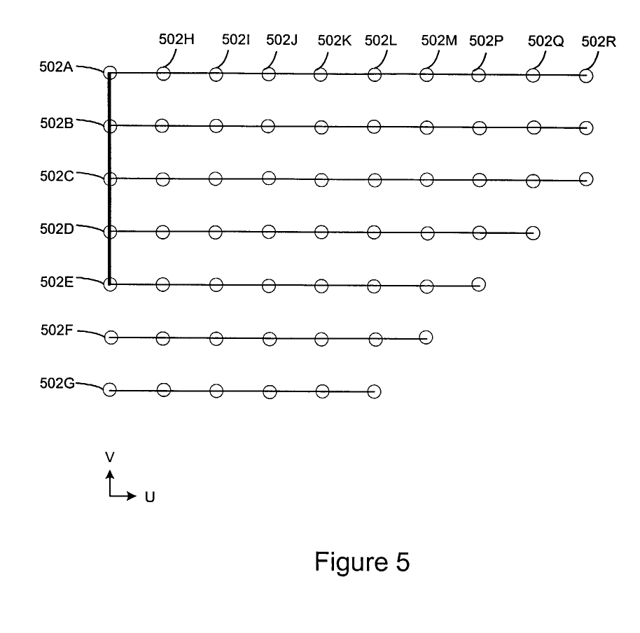

The data structure created by the model data creator is in the form of a network where each point has four pointers, e.g., a pointer identifying the next point in the U direction, a pointer identifying the next point in the V direction, a pointer identifying the previous point in the U direction, and a pointer identifying the previous point in the V direction. An illustration depicting a UV sample space is illustrated in FIG. 5. Each sample point 502 has nine dimensions and is associated with at least one additional sample point. For example, point 502A is associated with point 502B (nextV), and point 502H (nextU).

The definitions and equations set forth in table 1 are utilized below.

TABLE 1
Distx = square root (dx²+ dy²+ dz²)*S
Distn = square root (di²+ dj²+ dk²)
Distc = square root (dY²+ dCb²+ dCr²)
Dist9 = square root( (Distx*wl)² + (Distn*w2)² + (Distc*(Distc*w3))²)
Radius = Distx(AB)/Distn(AB)
Radius error = (1.0 − square root(1.0 − (.5*Distn
(AB))²)*Radius < .25 pixel
Visible error = square root(Distc(BM)² * Distx(AC)
* 16) < Threshold

In Table 1, “distx” is the distance in geometric (xyz) space, “S” is a scale factor that converts model space to projected pixels at a desired dpi (e.g., 72 dpi). “distn” is the distance in normal (ijk) space. “distc” is the distance in the color (rgb) space. “dist9” is the distance in 9 dimensional space. Where W1=32, this converts pixel distances to match 0 to 255 color space. W2=255, this converts 0 to 1.0 f normal space to 0 to 255 color space. W3=1/255.0 f, this converts color to fraction, color is squared here since YCbCr is a square root function of linear color.

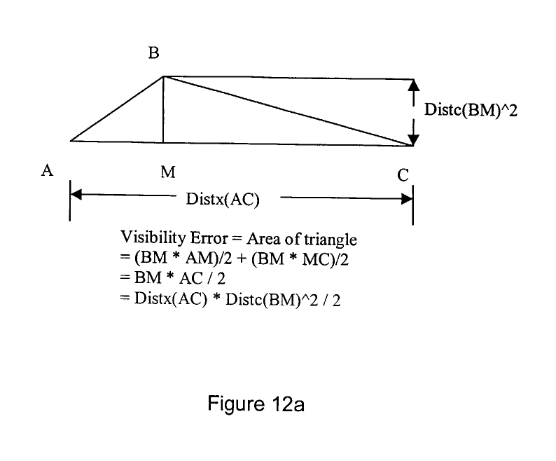

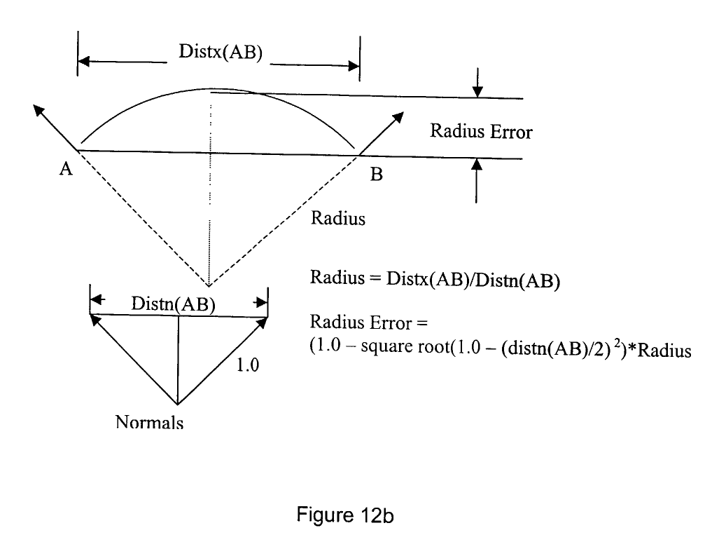

Referring to FIG. 12a, the “Radius error” is the error between the “true” curved distance between two points, e.g., A and B, (based upon the values of the normal at both points) and the straight line distance between the two points.

Referring to FIG. 12b, the “visibility error” determines the error with 3 points A, B, C if interior point B is removed and A and C are connected. “M” is the linear interpolated point between points “A” and “C” at position distx(AB)/distx(AC). Distc is the color distance between B and M. Distx is the geometric distance between points A and C and the threshold can be a variety of values, e.g., 25 for high quality.

Y, Cb and Cr are related to RGB (0 to 255) according to equation (1).

Y=0.256789063*red+0.504128906*green+0.09790625*blue+16.0

Cb=−0.148222656*red−0.290992188*green+0.439214844*blue

Cr=0.439214844*red−0.367789063*green−0.071425781*blue Eq. (1)

Surface Map Optimization

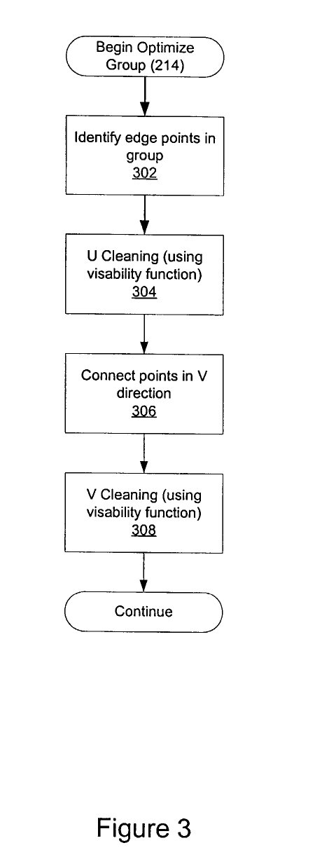

After the surface map creator 120 creates a surface map by sampling each shape in the structure, the surface map optimizer 130 selects 210 a shape and then selects 212 a group within the selected shape. In alternate embodiments, the sampling can be done on a shape by shape basis or a group by group basis. For the selected group the surface map optimizer 130 optimizes 214 the group. FIG. 3 is a flowchart describing the method for optimizing a group according to one embodiment of the present invention. The edge unit 132 identifies 302 edge points of the group. Edge points are points 502 that are part of an edge in another group. The end points are connected using the nextV and previousV pointers into a V-line. For example, in FIG. 5, data points 502A-E are end points and they are connected by a V-line. V-lines and data point connections can be done using the data structure described above by associating each of the data points using the next V and previous V elements of the data structure and a flag can be set that prevents their deletion. That is, the description of V-lines in this document is for ease of discussion and the creation of such lines is not necessary for the operation of this invention.

As described above, the present invention insures that the number of sample points exceeds the actual number of data points necessary to properly render the group. In order to reduce the number of polygons, hereafter referred to as triangles although the present invention is not limited to the rendering of triangles, the present invention optimizes each group by removing data points that are not necessary to render the group. One aspect of the present invention is that data points are removed from the group surface map if the present invention deems that, when rendered, a viewer would not be able to determine that the data point is missing. The present invention uses the visibility function described above with reference to Table 1 to identify those data points that can be deleted without creating a visible error in the resulting surface map when rendered or projected on a screen, e.g., a computer screen or a television screen to name two examples.

U—Cleaning

The U cleaning unit 134 of the surface map optimizer 130 performs 304 U-axis cleaning. By analyzing three points at a time in the U dimension, it determines whether the interior point is needed by using the visibility algorithm defined previously. The outer 2 points are also tested for radius error. If the visible error is less than a threshold and the radius error is less than the radius threshold, this point can be removed. This process is repeated until no further points can be removed. For example, with reference to FIG. 5, if the U cleaning unit 132 selects data points 502A, 502H and 502I (referred to as points 1, 2, and 3, respectively), then these data points are used as the inputs to the visibility function.

If based upon application of the visibility function, the value of point 2 is within a threshold value of the linear interpolation of point 1 and point 3 then point 2 can be deleted since the present invention can use a Gouraud shading technique that linearly interpolates between points 1 and 3. More specifically, in using the Gouraud shading technique the present invention assigns colors to each vertex, and these colors are linearly blended across the face of the polygon that results in the data at point 2 being redundant and therefore unnecessary.

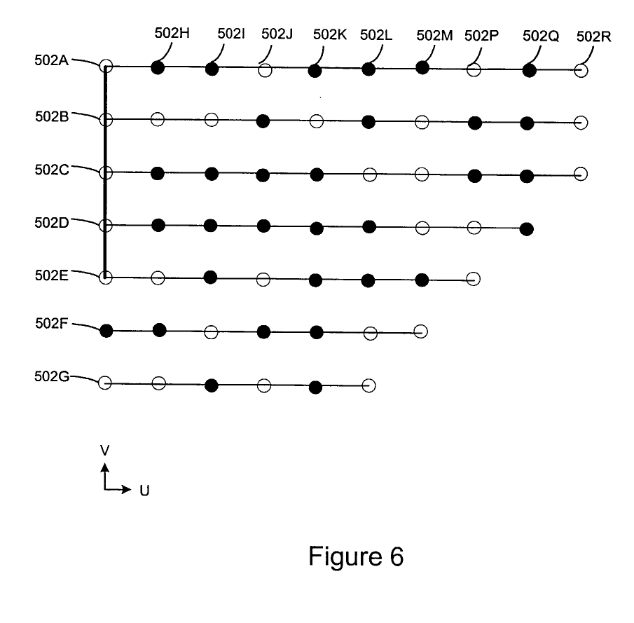

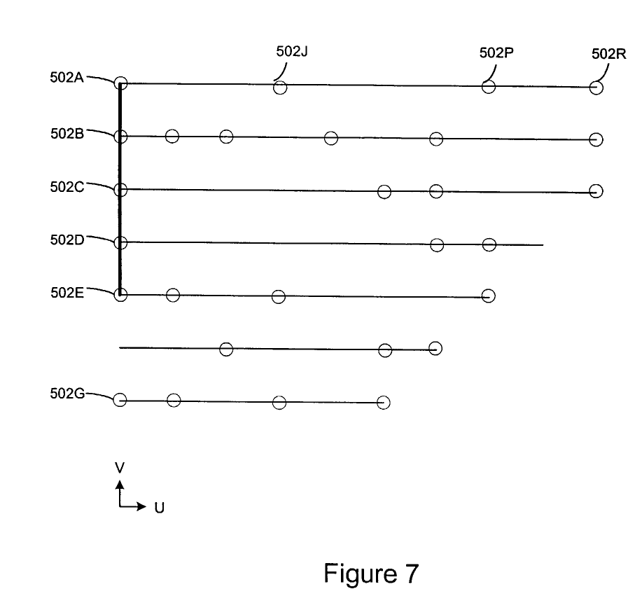

In this example the U cleaning unit 134 determines that point 502H is not necessary. The U cleaning unit 134 deletes point 502H and connects point 502A directly to point 502I. In the embodiment using the data structure described above, the “nextU” pointer for point 502A now points to point 502I and the “previousU” pointer for point 502I now points to point 502A. This process then repeats with points 502A, 502I, and 502J being points 1, 2, and 3. This process repeats across all data until no further data can be removed. FIG. 6 is an illustration of an example of the U cleaning procedure according to one embodiment of the present invention. In FIG. 6 the points that have been deleted are filled in black, e.g., 502H. FIG. 7 is an illustration of an example of the U cleaning procedure with the identified points removed according to one embodiment of the present invention. The points removed correspond to the points that were identified as being removed, as illustrated in FIG. 6. The result is that the group illustrated in FIG. 7 has been cleaned in the U direction.

V Line—Connection

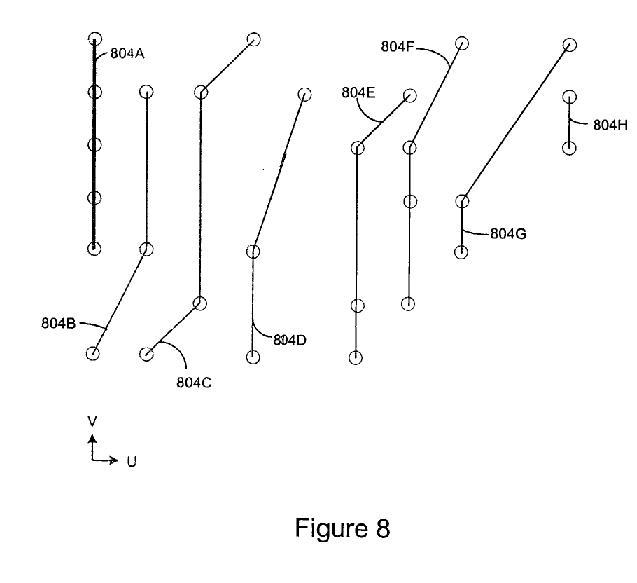

Delaunay Triangulation is a conventional technique that teaches that the optimal triangulation is a connection from each point to its two nearest neighbors to form a triangle. In one embodiment of the present invention we use the “dist9” function, described above, (9 dimensional distance) to determine which neighbors are nearest in order to form a triangle. If the present invention merely connected these points, a good picture would result, but too many triangles would be present. For each triangle that can be formed, the present invention connects only the 2 points on the shortest leg (minimum dist9) using the V connectors (nextV and previousV). This forms a series of interconnecting V-lines. FIG. 8 is an illustration of a result of a V-line creation process according to one embodiment of the present invention.

V Line—Cleaning

In FIG. 8 all points that have not been deleted by the U cleaning unit 134 are included in one of the V-lines 804A-F. In one embodiment of the present invention the data structure described above is modified so that for each point in a V-line, an adjacent point in the V-line is identified by the next V pointer and/or the previous V pointer, as described above.

The V cleaning unit 136 then reviews points on each of the V-lines and deletes those points that are not necessary using the same visibility and radius error rules described above with reference to the U cleaning unit 134.

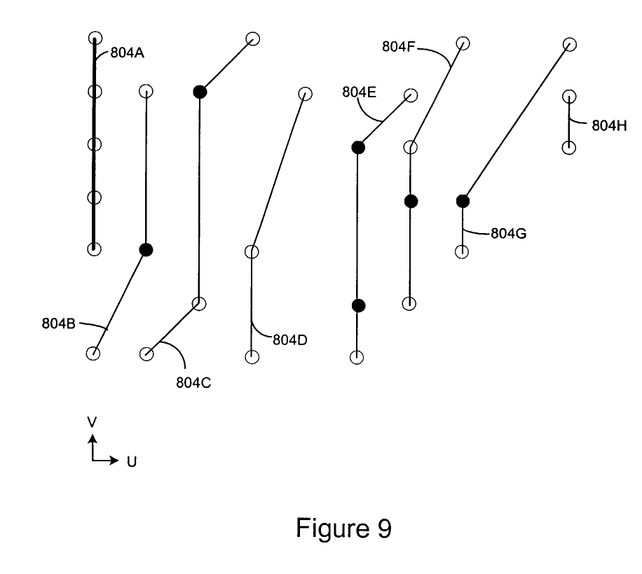

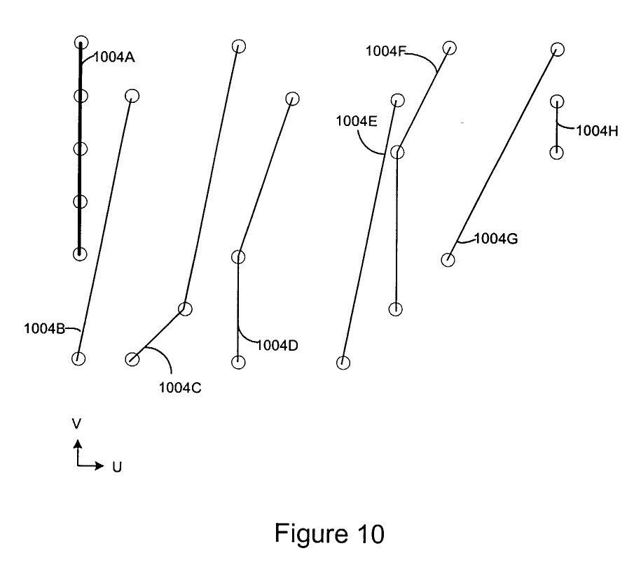

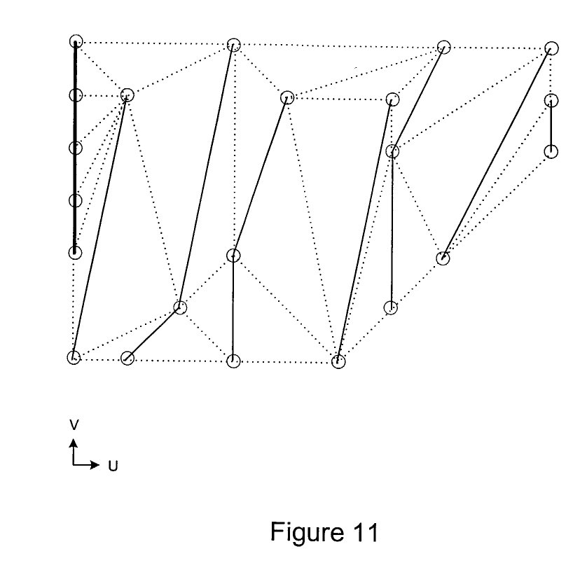

FIG. 9 is an illustration of the V-cleaning procedure according to one embodiment of the present invention. In FIG. 9, the points that have been deleted by the V cleaning unit 136 are represented by a circled filled in black. These points are removed and the resulting V lines are illustrated in FIG. 10. Each line 1004 in FIG. 10 represents a “clean” V-line 1004 that results from the cleaning 306 in the U direction by the U cleaning unit 134 and cleaning 308 in the V direction by the V cleaning unit 136.

Polygon Extraction

Once the U and V cleaning operation are complete, the remaining sets of data can be thought of as separate polygons connected by V-Lines which share edges. Each N sided polygon is then tessellated separately.

Polygon Triangulation

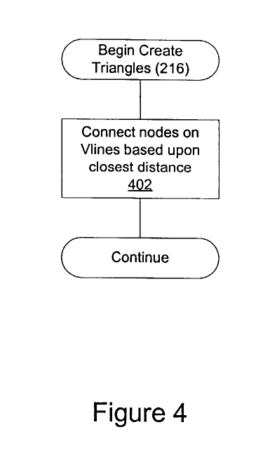

With reference to FIG. 2, the next step is to create 216 triangles based on the clean V-lines 1004. The polygon creation unit 140 receives the clean V-lines 1004 and the polygon unit 142 creates the triangles. FIG. 4 is a flowchart describing the method for creating triangles for a group according to one embodiment of the present invention. The present invention creates 216 triangles by connecting 402 nodes on V-lines based upon the closest distance. Polygon Triangulation is a well-known problem with a variety of solutions. One such technique is described here although a variety of different techniques can be used as part of the present invention. One embodiment of the present invention uses dist9 function (9 dimensional distance) in the formulas. Since Delaunay states that the optimal triangulation is with the 2 nearest neighbors, and the points along the V-Line are the closest neighbors, each point in the polygon is connected to it's nearest (dist9) neighbor that is not adjacent to it on the V-line to finish the Delaunay triangulation. Distances (dist9) for every possible connection inside the polygon are sorted and the shortest distances are connected first until all area is only triangles. Once all triangles are formed, color data at each point is reconverted to RGB from YCbCr (as shown below in equation (2)) so the graphics engines can render the triangles.

Y1=Y−16.0

red=1.164382813*Y1+0*Cb+1.596027344*Cr

green=1.164382813*Y1−0.391761719*Cb−0.81296875*Cr

blue=1.164382813*Y1+2.017230469*Cb+0*Cr Eq. (2)

FIG. 11 is an illustration of an example of the triangle creation process according to one embodiment of the present invention. The present invention traverses through each node of each V-line 1004 and identifies the closest node. Once the first triangle is formed, each additional line creates a new triangle. In FIG. 11, the V-lines 1004 are represented as solid lines and the new line segments are represented as dashed lines. The output of the polygon unit 142 is data representing the output triangles for the optimized surface map of the selected group.

The surface map optimizer 130 then determines 220 whether any more groups are in the selected shape. If so, the process repeats and a new group is selected 212. Any new points introduced into shared edges are carried forward into the next group so shared edges remain consistent. Once all of the groups in the selected shape are processed, the surface map optimizer 130 determines 222 whether any more shapes are in the structure. If so, the process repeats and a new shape is selected 210. If not, the resulting output is the output triangles for the optimized surface map for all the shapes.

While the invention has been particularly shown and described with reference to a preferred embodiment and several alternate embodiments, it will be understood by persons skilled in the relevant art that various changes in form and details can be made therein without departing from the spirit and scope of the invention.

What is claimed is:

1. A computerized method of assimilating and organizing data regarding a surface, called surface map data, so that, for a given amount of data at a given scale/resolution, the surface may be better imaged, the method comprising:
re-sampling the surface map data as a vector-valued field in a parametric U and V grid space, where each vertex in UV space includes surface information including at least (1) position and (2) color;
removing vertex points in accordance with a visibility function so that any points that are less substantially contributory to visual distinctiveness of an image of the surface ultimately to be generated using remaining vertex points are removed;
reconnecting remaining vertex points to form polygons;
splitting the polygons into triangles; and
displaying the resulting set of triangles as an image.

2. The computerized surface map data assimilation and organization method according to claim 1
wherein the re-sampling of the surface map data produces vertices in UV space each of which vertices includes (1) position and both (2a) normal color and (2b) diffuse color, ergo complete effects of texture, of the surface.

3. The computerized surface map data assimilation and organization method according to claim 1
wherein the removing of vertex points is in accordance with a visibility function in respect of a surface image generation error based on difference in color between vertex points.

4. The computerized surface map data assimilation and organization method according to claim 1
wherein the removing of vertex points is in accordance with a visibility function in respect of a surface image generation error based on difference in spatial coordinates between vertex points.

5. The computerized surface map data assimilation and organization method according to claim 1
wherein the removing of vertex points is in accordance with a visibility function in respect of a surface image generation error based on difference in vectors normal to the surface between vertex points.

6. A method of compressing data defining a surface map comprising:
first-providing a data structure to store parametric information defining the points of a surface;
second-providing a first set of data points from the surface map, the first set of data points having associations defined in both a first parametric dimension and a second parametric dimension;
defining with a first function a first parametric error;
selectively removing along the first parametric dimension from the first set of points in accordance with the first function points that are less contributory to error in the first parametric dimension, leaving an abbreviated second set of points;
selectively connecting points from the abbreviated second set of points to form sets of linked points;
defining a second function defining a second parametric error; and
selectively removing along the second parametric dimension from the sets of linked points in accordance with the second function points that are less contributory to error in the second parametric dimension, leaving an abbreviated third set of points that are suitably displayed as an image of the surface;
wherein the first set of data points from the surface map are abbreviated in each of two parametric dimensions before being, as an abbreviated third set of points, suitably displayed as an image of the surface.

7. The method of claim 6
wherein the first function and the second function are the same.

8. The method of claim 6 wherein at least one of the first function and the second function comprises:
an error function responsive to differences in color.

9. The method of claim 6 wherein at least one of the first function and the second function comprises:
an error function responsive to differences in spatial coordinates.

10. The method of claim 6 wherein at least one of the first function and the second function comprises:
an error function responsive to differences in vector normal to the surface.

11. A method of reducing the data defining a surface map comprising:
first-providing a data structure to store information in a first parametric dimension defining the points of a surface;
second-providing from the surface map a set of points defined in at least the first parametric dimension;
providing a first function defining a first parametric error as a difference between (1) a value, in the first parametric dimension, of a given point, and (2) a value, in the first parametric dimension, interpolated or extrapolated from at least one neighboring point to the given point; and
selectively removing points from the set of points in accordance with the first function so as to eliminate points having little error in the first parametric dimension, leaving a reduced set of points stored within the data structure.

12. The method of claim 11
wherein the first function defines parametric error in a dimension of color.

13. The method of claim 11
wherein the first function defines parametric error in a dimension of a vector normal to the surface.

14. The method of claim 11
wherein the first function defines parametric error in a dimension of positional coordinates.

15. A method of optimizing data defining a surface map comprising:
providing a data structure to store parametric information about the surface map;
storing a first set of points containing parametric information about the surface map into the data structure, the stored parametric information including at least information regarding surface color;
selectively connecting points from the first set of points to form sets of linked points, the linked points of a set being chosen to minimize any difference in at least one parametric value, the at least one minimized-difference parametric value including color;
providing at least one function defining an error;
selectively removing points from the first set of points in accordance with the at least one error-defining function to provide a second set of points.

16. The method of claim 15 further comprising, before the selectively removing points, the step of:
selectively pairing the points in sets n accordance with at least one parameter;
where the selectively removing points is of one point from at least some of the sets of paired points.

17. The method of claim 15 wherein the at least one parametric value is a function of spatial coordinates.

18. The method of claim 15 wherein the at least one parametric value is a function of a vector normal to the surface.
